(19) United States
(12) Patent Application Publication
(10) Pub. No.: US 2026/0353441 A1
(43) Pub. Date: Nov. 5, 2026

(54) METHODS AND APPARATUSES FOR HANDLING CONSISTENT LBT FAILURE

(71) Applicant: LENOVO (BEIJING) LIMITED, Beijing (CN)

(72) Inventors: Jing HAN, Beijing (CN); Lianhai WU, Beijing (CN); Ran YUE, Beijing (CN); Jie HU, Beijing (CN); Haiming WANG, Beijing (CN)

(21) Appl. No.: 19/101,733

(22) PCT Filed: Aug. 9, 2022
(86) PCT No.: PCT/CN2022/111157

§ 371 Date: Feb. 6, 2025

(51) Int. Cl. H04W 74/0808; H04W 72/25; H04W 76/19

(52) U.S. Cl. CPC H04W 74/0808; H04W 72/25; H04W 76/19

(57) ABSTRACT

The present application relates to methods and apparatuses for handling a consistent listen before talk (LBT) failure. An embodiment of the present disclosure provides a user equipment (UE), comprising: a transceiver; and a processor coupled with the transceiver and configured to: detect a consistent LBT failure in a first sidelink (SL) bandwidth part (BWP); perform at least one of the following: deactivate the first SL BWP; reset the first SL BWP; recover SL transmission(s) in the first SL BWP in response to one or more conditions being fulfilled; or recover the SL transmission(s) in a second SL BWP.

### TECHNICAL FIELD

The present disclosure relates to wireless transmission, and more particularly relates to methods and apparatuses for handling a consistent listen before talk (LBT) failure.

### BACKGROUND OF THE INVENTION

In new radio unlicensed (NRU) spectrum, plenty of unlicensed bands or channels can be used for wireless transmission (e.g., WiFi, Bluetooth, 3G, 4G, etc.). An LBT procedure is performed before each transmission to determine whether the unlicensed band or channel is available. If LBT fails, which means the channel has been occupied, an LBT failure indication is sent to the media access control (MAC) entity from lower layers (e.g., a physical (PHY) layer). Then the MAC entity may count the number of LBT failure indication from lower layer in a time period, and trigger a consistent LBT failure when the number of LBT failure indication exceeds a threshold (for example, a preconfigured maximum number within the time period).

Sidelink (SL) is a direct link for communications between devices used for several applications, such as proximity service (Device to Device (D2D)), Vehicle to Vehicle (V2V), Vehicle to Passenger (V2P), Internet of Things (IoT), wearable, etc. SL transmission, which may also be operated on an unlicensed band for public safety or commercial use, is required to perform the similar LBT procedure defined in the NRU as discussed above. However, SL transmission would not be initiated if consistent LBT failure is detected or triggered for a sidelink bandwidth part (SL BWP) since only one SL BWP is supported for sidelink. That is, if the LBT failure is counted for the SL BWP, after a consistent LBT failure is triggered, the whole SL BWP is regarded as failure and SL transmission cannot be performed. Failure of the SL transmission can jeopardize public safety or commercial interest.

Therefore, it is desirable to provide solutions for handling a consistent LBT failure in SL BWP in an SL-U system; furthermore, it is advantageous to provide solutions for recovering the SL communication.

### SUMMARY

An embodiment of the present disclosure provides a user equipment (UE), comprising: a transceiver; and a processor coupled with the transceiver and configured to: detect a consistent LBT failure in a first SL bandwidth part (BWP); perform at least one of the following: deactivate the first SL BWP; reset the first SL BWP; recover SL transmission(s) in the first SL BWP in response to one or more conditions being fulfilled; or recover the SL transmission(s) in a second SL BWP.

In some embodiments, the processor is further configured to: determine to deactivate the first SL BWP autonomously; or determine to deactivate the first SL BWP based on an indication from the BS indicating the UE to deactivate the first SL BWP.

In some embodiments, the processor is further configured to perform at least one of the following in the first SL BWP: suspend PC5 interface radio resource control (PC5-RRC) connection(s) of all established unicast connection(s); trigger an SL radio link failure (RLF) for all established unicast connection(s); or release all established unicast connection(s) and indicate the release to an upper layer.

In some embodiments, suspending the PC5-RRC connection(s) of all established unicast connection(s) further includes at least one of the following: storing the PC5-RRC configuration(s) of all suspended unicast connection(s); or indicating, to the upper layer, all suspended unicast connection(s).

In some embodiments, the processor is further configured to recover all suspended unicast connection(s) in response to the first SL BWP being recovered.

In some embodiments, the processor is further configured to: determine to reset the first SL BWP autonomously; or determine to reset the first SL BWP based on an indication from the BS indicating the UE to reset the first SL BWP.

In some embodiments, the processor is further configured to perform at least one of the following in the first SL BWP: release data resource block(s) (DRB) of all destinations; release signaling resource block(s) (SRB) of all destinations; discard SL communication related configuration(s) of all destinations; reset SL specific MAC of all destinations; or consider the PC5-RRC connection(s) as released for all unicast destinations.

In some embodiments, the one or more conditions include: a timer being expired; an LBT success number associated with the first SL BWP being higher than a first threshold; an LBT failure number associated with the first SL BWP being lower than a second threshold; a result of a channel busy ratio (CBR) measurement on the first SL BWP being lower than a third threshold; or an indication from the BS indicating that the first SL BWP is reconfigured.

In some embodiments, the processor is further configured to perform at least one of the following: indicate the consistent LBT failure in the first SL BWP to an upper layer; transmit an indication indicating the consistent LBT failure in the first SL BWP to the BS; or trigger a cell section procedure or a cell resection procedure.

In some embodiments, the upper layer is configured to perform at least one of the following: stop SL transmission to all destinations; suspend or release all unicast connections; or configure the second SL BWP.

In some embodiments, the indication indicating the consistent LBT failure in the first SL BWP includes a medium access control (MAC) control element (CE) or radio resource control (RRC) signalling.

In some embodiments, the RRC signalling indicating the consistent LBT failure in the first SL BWP includes at least one of the following: an RRC setup request message including a cause or an information element (IE) that indicates the consistent LBT failure in the first SL BWP; an RRC setup complete message including an IE that indicates the consistent LBT failure in the first SL BWP; an RRC resume message including an IE that indicates the consistent LBT failure in the first SL BWP; an RRC resume complete message including an IE that indicates the consistent LBT failure in the first SL BWP; an RRC reestablishment message including an IE that indicates the consistent LBT failure in the first SL BWP; an RRC reestablishment complete message including an IE that indicates the consistent LBT failure in the first SL BWP; an SL UE information message, wherein the SL UE information message includes an SL failure IE with an parameter of destination indicating the consistent LBT failure is associated with all destinations or associated with the first SL BWP, and includes a cause that indicates the consistent LBT failure in the first SL BWP; or wherein the SL UE information message includes an IE that indicates the consistent LBT failure in the first SL BWP.

In some embodiments, the processor is further configured to: receive a system information block or dedicated signalling indicating the second SL BWP.

In some embodiments, the processor is further configured to perform at least one of the following: release stored PC5-RRC configurations; apply PC5-RRC configurations for the second SL BWP; or recover all suspended unicast connection(s).

In some embodiments, the processor is further configured to: select a cell with a higher priority level during the cell section procedure or the cell resection procedure, wherein the cell with a higher priority level is associated with SL communications in an unlicensed band.

Another embodiment of the present disclosure provides a base station (BS), comprising: a transceiver; and a processor coupled with the transceiver and configured to: receive, from a UE, an indication indicating a consistent LBT failure in a first SL BWP; and transmit, to the UE, a second SL BWP in a system information block or dedicated signalling.

In some embodiments, the indication includes a MAC CE or radio resource control (RRC) signalling.

Yet another embodiment of the present disclosure provides a method performed by a UE, comprising: detecting a consistent LBT failure in a first SL BWP; performing at least one of the following: deactivating the first SL BWP; resetting the first SL BWP; recovering SL transmission(s) in the first SL BWP in response to one or more conditions being fulfilled; or recovering the SL transmission(s) in a second SL BWP.

Still another embodiment of the present disclosure provides a method performed by a base station (BS), comprising: receiving, from a UE, an indication indicating a consistent LBT failure in a first SL BWP; and transmitting, to the UE, a second SL BWP in a system information block or dedicated signalling.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates a method performed by an SL UE for handling a consistent LBT failure according to some embodiments of the present disclosure.

FIGS. 3A-3C illustrate methods performed by an SL UE for handling a consistent LBT failure according to some embodiments of the present disclosure.

FIG. 4 illustrates a method performed by an SL UE for handling a consistent LBT failure according to some embodiments of the present disclosure.

FIG. 5 illustrates a method performed by an SL UE for handling a consistent LBT failure according to some embodiments of the present disclosure.

FIG. 6 illustrates a method performed by a BS for handling a consistent LBT failure according to some embodiments of the present disclosure.

FIG. 7 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

UE under NR SL-U scenario may be referred to as SL UE(s). An SL UE which transmits data on sidelink in an unlicensed spectrum may be referred to as a UE for transmitting, a transmitting UE, a transmitting SL UE, a Tx SL UE, a Tx UE, an SL Tx UE, an SL BWP Tx UE, a UE, or the like. An SL UE which receives data on sidelink in an unlicensed spectrum may be referred to as a UE for receiving, a receiving UE, a receiving SL UE, an Rx UE, an Rx SL UE, an SL Rx UE, a UE, or the like.

SL UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, personal computer (PC), game terminal, extended reality (XR) devices, or the like.

According to some embodiments of the present disclosure, SL UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present disclosure, SL UE(s) may include wearable devices, such as smart watches, fitness bands, optical head-mounted displays, or the like. Moreover, SL UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. SL UE(s) may communicate directly with BS(s) via communication signals.

A BS under NR SL-U scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME) or an access and mobility management function (AMF), a serving gateway (SGW), a packet data network gateway (PGW), and/or or a user plane function (UPF).

A BS may serve a number of SL UEs within a serving area, for example, a cell or a cell sector via a wireless communication link. A BS may communicate directly with one or more SL UEs via communication signals. For example, a BS may serve SL UEs within a macro cell.

Sidelink communication between a Tx UE and a receive (Rx) UE under NR SL-U scenario includes groupcast communication, unicast communication, or broadcast communication.

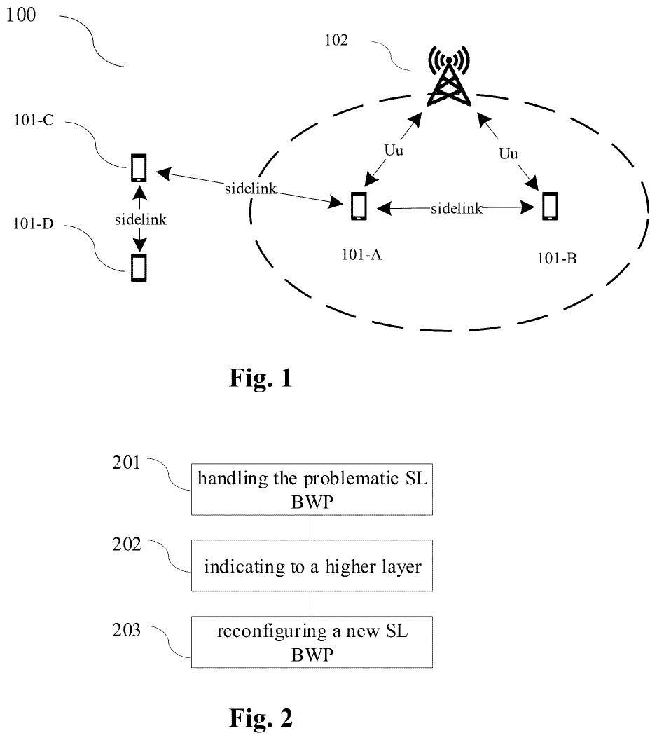

FIG. 1 illustrates a wireless communication system 100 (e.g., an SL-U communication system) in accordance with some embodiments of the present disclosure.

As shown in FIG. 1, the wireless communication system 100 includes a base station (e.g., BS 102), and some UEs (e.g., UE 101-A, UE 101-B, UE 101-C, and UE 101-D). UE 101-A and UE 101-B are within the coverage of BS 102, and UE 101-C and UE 101-D are outside the coverage of BS 102. UE 101-A, UE 101-B, UE 101-C, and UE 101-D may perform sidelink unicast transmission, sidelink groupcast transmission, or sidelink broadcast transmission in an unlicensed spectrum, such as the SL BWP. UE 101-A, UE 101-B, UE 101-C, and UE 101-D may be referred to as an SL UE. It is contemplated that, in accordance with some other embodiments of the present disclosure, an SL-U communication system may include more BSs and more or fewer SL UEs.

In addition, although the SL UEs as shown in FIG. 1 are illustrated in the shape of a cellphone, it is contemplated that an SL communication system may include any type of UE (e.g., a roadmap device, a cell phone, a computer, a laptop, IoT device or other type of device) in accordance with some other embodiments of the present disclosure.

According to some embodiments of FIG. 1, UE 101-A may function as a Tx UE, and UE 101-B, UE 101-C, and UE 101-D may function as Rx UEs. UE 101-A may exchange SL messages with UE 101-B or UE 101-C through a sidelink using, for example, the NR technology or the LTE technology, through PC5 interface as defined in 3GPP documents. UE 101-A may transmit information or data to other UE(s) within the SL-U communication system through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Alternatively, according to some other embodiments of FIG. 1, UE 101-B or UE 101-C may function as a Tx UE and transmit information or data, and UE 101-A may function as an Rx UE and receive information or data from UE 101-B or UE 101-C.

Both UE 101-A and UE 101-B in the embodiments of FIG. 1 may transmit information to BS 102 and receive control information from BS 102, for example, via a Uu interface. BS 102 may define one or more cells, and each cell may have a coverage area. As shown in FIG. 1, both UE 101-A and UE 101-B are within the coverage of BS 102, while UE 101-C and UE 101-D are not.

The BS 102 as illustrated and shown in FIG. 1 may not be a specific base station, but may be any base station(s) in the SL-U communication system. For example, assuming that the SL-U communication system includes two BSs, UE 101-A being within a coverage area of any one the two BSs may be called as a case that UE 101-A is within the coverage of a BS in the SL-U communication system; and only UE 101-A being outside of coverage area(s) of both BSs may be called as a case that UE 101-A is outside of the coverage of a BS in the SL-U communication system.

UEs may operate in different modes. At least the following two sidelink resource allocation modes are defined for sidelink communication: resource allocation mode 1: a BS may schedule a sidelink resource(s) to be used by a UE for sidelink transmission(s); and resource allocation mode 2: a UE may determine a sidelink transmission resource(s) within sidelink resources configured by a BS or network, or pre-configured sidelink resources. In resource allocation mode 2, a BS may not schedule the sidelink resources for a UE. In FIG. 1, UE 101-A and UE 101-B may be in resource allocation mode 1, and UE 101-C and UE 101-D may be in resource allocation mode 2. In some other cases, UE 101-A and UE 101-B may also operate in resource allocation mode 2. Hereinafter in the present disclosure, “mode 1” may refer to resource allocation mode 1, and “mode 2” may refer to resource allocation mode 2.

A consistent LBT failure may be detected for an SL BWP, an SL carrier, an SL band, etc. The SL BWP or SL carrier with a consistent LBT failure may be referred as “problematic SL BWP” or “problematic SL carrier.” Hereinafter in the present disclosure, the term “SL carrier” or “SL BWP” may be used interchangeably where appropriate.

For NR sidelink, only one carrier may be configured, and only one BWP is supported for one carrier. In the case that a consistent LBT failure is detected for the SL BWP, the entire SL communication may be stalled. In NR sidelink, there may be an SL RLF procedure to handle the radio link failure problem. However, the SL RLF procedure may only target the unicast link, which cannot solve the problem thoroughly. Accordingly, solutions for handling a consistent LBT failure in the SL BWP or SL carrier and solutions for recovering the SL communications are needed.

In particular, the solutions of the present disclosure relate to two aspects, 1): solutions for handling the consistent LBT failure in the SL BWP or SL carrier; and 2): solutions for recovering the SL communications.

Regarding how to handle the consistent LBT failure in the SL BWP (or SL carrier, hereinafter in the present disclosure, only the term “SL BWP” is used, and it should be noted that the term “SL BWP” may be replaced by “SL carrier”), several solutions are presented as follows:

### Solution 1-1:

In this solution, when a consistent LBT failure in the SL BWP is detected, or a consistent LBT failure is triggered for the SL BWP, deactivation of the SL BWP may be triggered. In other words, the SL UE may deactivate the SL BWP.

In one embodiment, the SL UE may be in an RRC_IDLE state, an RRC_INACTIVE state, or resource allocation mode 2, or the SL UE may be out of coverage. When a consistent LBT failure in the SL BWP is detected, or a consistent LBT failure is triggered for the SL BWP, the SL UE may deactivate the SL BWP autonomously.

In another embodiment, the SL UE may be in an RRC_CONNECTED state, resource allocation mode 1, or the SL UE may be in coverage. When a consistent LBT failure in the SL BWP is detected, or a consistent LBT failure is triggered for the SL BWP, the SL UE may report to the BS regarding the consistent LBT failure for the SL BWP. The BS may transmit an indication to the UE, which indicates the UE to deactivate the SL BWP. Upon receiving the indication for deactivation of the SL BWP from the BS, the SL UE may deactivate the SL BWP.

In particular, the deactivation of the SL BWP may include the following operations:
The SL UE may perform at least one of the following:
   stop transmission or reception for sidelink;
   suspend the CG type1 grant;
   Clear the Cg Type2 Grant; or
   cancel the scheduling request (SR), the buffer status report (BSR), SL-channel state information (CSI) if triggered.
In the case that the SL UE has been configured with only one SL BWP, the SL UE may handle the unicast connection(s) with at least one of the following options:
   Option 1-1: the SL UE may suspend a PC5-RRC connection(s) of all established unicast connections. In particular, the SL UE may store the PC5-RRC configurations for all suspended unicast connections per unicast connection. The SL UE may report (or indicate) the suspended unicast connection(s) to higher layers, for example, the V2X layer.
   In some embodiments, when the problematic SL BWP is recovered, the SL UE may recover all the suspended unicast connections. In some other embodiments, the SL UE may be indicated with a new SL BWP, and the SL-U communication may be recovered in the new SL BWP, the SL UE may release all the stored PC5-RRC configurations, and apply the PC5-RRC configurations to the new SL BWP, whereby all the suspended unicast connections may be recovered.
Option 1-2: the SL UE may consider a sidelink radio link failure, and may trigger an SL RLF for all established unicast connections.
Option 1-3: the SL UE may release SL data RB(s) and SL signalling RBs, discard the corresponding radio configurations, reset the MAC layer, consider the PC5-RRC connection is released for all unicast connections and be report (or indicate) to a higher layer of the UE.

### Solution 1-2:

In this solution, when a consistent LBT failure in the SL BWP is detected, or a consistent LBT failure is triggered for the SL BWP, an SL BWP reset may be triggered.

In one embodiment, the SL UE may be in an RRC_IDLE state, an RRC_INACTIVE state, or resource allocation mode 2, or the SL UE may be out of coverage. When a consistent LBT failure in the SL BWP is detected, or a consistent LBT failure is triggered for the SL BWP, the SL UE may reset the SL BWP autonomously.

In another embodiment, the SL UE may be in an RRC_CONNECTED state, resource allocation mode 1, or the SL UE may be in coverage. When a consistent LBT failure in the SL BWP is detected, or a consistent LBT failure is triggered for the SL BWP, the SL UE may report to the BS, which indicates the consistent LBT failure for the SL BWP. The BS may transmit an indication to the UE, which indicates the UE to reset the SL BWP. Upon receiving the indication for reset of the SL BWP from the BS, the SL UE may reset the SL BWP.

In particular, the reset of the SL BWP may include the following operations:
release the DRBs of all destinations, all destinations may include all unicast destinations, all broadcast destinations, all groupcast destinations, or any other destinations;
release the SRBs of all destinations;
discard the NR sidelink communication related configuration(s) of all destinations;
reset the sidelink specific MAC of all destinations; or
consider the PC5-RRC connection(s) is released for all unicast destinations.

Regarding how to recover the SL communication after a consistent LBT failure is triggered in the SL BWP, the present disclosure proposes that the SL communication may be recovered in the problematic SL BWP, or in a new SL BWP, and the details are described in the following solutions.

### Solution 2-1:

In solution 2-1, the SL communication may be recovered in the problematic SL BWP. The SL UE may take the following options to recover the SL communication in the problematic SL BWP as follows:

### Option 2-1A:

Option 2-1A relates to an SL UE operating in resource allocation mode 1 or resource allocation mode 2. When a consistent LBT failure is triggered for a SL BWP, the SL UE may start a timer, and the length of the timer may be indicated by the network, for example, via an indication from the BS, or may be preconfigured, or configured. The SL UE may also deactivate the SL BWP as described in option 1 above.

When the timer is running, i.e., during the time period of the timer, the SL UE may be prohibited from performing SL communication in the SL BWP, in other words, the resources in a SL BWP are prohibited from being used for SL communication. When the timer expires, the SL UE may consider that the problematic SL BWP is recovered, i.e., the SL BWP may be used for SL communication, and the SL UE may recover all the suspended unicast connections. The SL BWP may also be referred to as available when the timer expires.

### Option 2-1B:

Option 2-1B relates to an SL UE operating in resource allocation mode 1 or resource allocation mode 2. When a consistent LBT failure is triggered for a SL BWP, the SL UE may perform an LBT procedure on the SL BWP continuously. For example, the SL UE may perform an LBT procedure on the SL BWP in a periodical manner. The LBT procedure may be any type of LBT procedure, for example, LBT type 1, LBT type 2 a, LBT type b, LBT category 1 (Cat. 1), LBT Cat. 2, LBT Cat. 4, etc. The periodicity for performing the LBT procedure may be indicated by the BS, by the network, or may be configured or preconfigured.

In some embodiments, a first threshold and a time period may be used to determine whether the SL BWP is recovered or not. The first threshold may be associated with an accumulated LBT success number (or a consecutive LBT success number). The value(s) of the first threshold and/or the time period may be indicated by the BS, by the network, or may be configured or preconfigured. In the case that during the time period the accumulated LBT success number (or a consecutive LBT success number) is higher (or larger) than the first threshold, the SL BWP is regarded as recovered, or as available, and may be used for SL transmission.

In some embodiments, a second threshold and a time period may be used to determine whether the SL BWP is recovered or not. The second threshold may be associated with an accumulated LBT failure number. The value(s) of the second threshold and/or the time period may be indicated by the BS, by the network, or may be configured or preconfigured. In the case that during the time period the accumulated LBT failure number is smaller than the second threshold, the SL BWP is considered as recovered, or as available, and may be used for SL transmission.

### Option 2-1C:

Option 2-1C relates to an SL UE operating in resource allocation mode 1 or resource allocation mode 2. When a consistent LBT failure is triggered for a SL BWP, the SL UE may perform a CBR measurement on the SL BWP continuously, such as in a periodical manner. A threshold associated with the CBR measurement may be indicated by the BS, by the network, or may be configured or preconfigured. When a CBR measurement result is lower than the threshold, i.e., the load of the SL BWP is lower than the threshold, the SL BWP is considered as recovered, or as available, and may be used for SL transmission.

### Option 2-1D

Option 2-1D relates to an SL UE operating in resource allocation mode 1. When a consistent LBT failure is triggered for a SL BWP, the SL UE in mode 1 may receive an indication from the BS, which may indicate that the SL BWP is recovered, or reconfigured, or available. The UE then may consider the SL BWP as recovered or available. The BS may determine whether the SL BWP is recovered or available by collecting other SL-U UE transmission information on the SL BWP.

When an SL BWP is recovered, in the case that the UE may have labeled the SL BWP as problematic, or determined that the SL BWP is associated with a lower priority level (such as “low”), after the SL BWP is recovered, the UE may remove the problematic label, or determine that the SL BWP is associated with a higher priority level (such as “high”).

### Solution 2-2:

In solution 2-2, the SL communication may be recovered in a new SL BWP. The SL UE may take the following options to recover the SL communication in the new SL BWP as described in the following options:

### Option 2-2A

Option 2-2A relates to an SL UE out of coverage. The SL UE may indicate a consistent LBT failure of the SL BWP to an upper layer, e.g., the V2X layer or the NAS layer. For example, the AS layer may report the consistent LBT failure to the NAS layer. After receiving the indication, the NAS layer may stop the SL transmission to all destinations, and suspend or release the corresponding unicast connections. The NAS layer may reconfigure a new SL BWP for the AS layer to recover the SL communication in the AS layer.

FIG. 2 illustrates a method performed by an SL UE for handling a consistent LBT failure according to some embodiments of the present disclosure.

In operation 201, when a consistent LBT failure is triggered on the SL BWP (or the UE detects a consistent LBT failure on the SL BWP), the SL UE may handle the problematic BWP, for example, the SL UE may handle the problematic BWP as described in the above option 1 or option 2, i.e., the SL UE may deactivate the SL BWP autonomously, or may reset the SL BWP autonomously.

In operation 202, the SL UE may report (or indicate) a consistent LBT failure of the SL BWP to an upper layer, for example, the V2X layer or the NAS layer.

In operation 203, the upper layer may reconfigure a new SL BWP. The UE may recover the SL communications in the new SL BWP.

### Option 2-2B

Option 2-2B relates to an SL UE in an RRC_CONNECTED state, resource allocation mode 1, or the SL UE may be in coverage.

When a consistent LBT failure is triggered on the SL BWP (or the UE detects a consistent LBT failure on the SL BWP), the SL UE may report the consistent LBT failure of the SL BWP to the BS. In particular, the SL UE may transmit an indication, which indicates the consistent LBT failure of the SL BWP to the BS. The indication may be a MAC CE, or a RRC signalling.

In some embodiments, the indication may be a MAC CE, and the SL UE may transmit the MAC CE, which indicates the consistent LBT failure is triggered in the SL BWP, or indicate the SL UE has detected a consistent LBT failure in the SL BWP, or indicate that the SL BWP has failed and cannot be used. The MAC CE may be a zero bit MAC CE, for example, a MAC CE that only includes a sub-header.

In some other embodiments, the indication may be a RRC signalling.

When the SL UE is in an RRC_IDLE state or an RRC_INACTIVE state, it may be triggered to establish (or reestablish) the RRC connection with the BS and enter an RRC CONNECTED state. In this case, the RRC signalling may include the following:
an RRC setup request message, e.g., RRCSetupRequest message; wherein an IE is included in the message, or a cause (which may be an IE) is included in the message, to indicate the consistent LBT failure in the SL BWP;
an RRC setup complete message, e.g., RRCSetupComplete message, wherein an IE (or a cause) is included in the message, to indicate the consistent LBT failure in the SL BWP;
an RRC resume message, e.g., RRCResume message, wherein an IE (or a cause) is included in the message, to indicate the consistent LBT failure in the SL BWP;
an RRC resume complete message, e.g., RRCResumeComplete message, wherein an IE (or a cause) is included in the message, to indicate the consistent LBT failure in the SL BWP;
an RRC reestablishment message, e.g., RRCReestablishment message, wherein an IE (or a cause) is included in the message, to indicate the consistent LBT failure in the SL BWP;
an RRC reestablishment complete message, e.g., RRCReestablishmentComplete message, wherein an IE (or a cause) is included in the message, to indicate the consistent LBT failure in the SL BWP.

When the SL UE enters into the RRC CONNECTED state from the RRC_IDLE state or the RRC_INACTIVE state, or the SL UE is already in the RRC CONNECTED state, the SL UE may be triggered to send an SL UE information message, e.g., SidelinkUEInformationNR message, to the BS upon the triggering of the consistent LBT failure in the SL BWP.

The RRC signaling message may include an SL failure IE (e.g., SL-Failure IE). In the SL failure IE, the SL UE may set a default destination ID to sl-DestinationIdentity-r16, which indicates that all destinations of the SL communications have failed, or indicates a consistent LBT failure in the SL BWP.

Additionally, the SL UE may set a cause for sl-Failure-r16, (e.g., consistentLBTfailure) to indicate that a consistent LBT failure has happened in the SL BWP. Alternatively, the SL UE may use an IE in the RRC signaling message (e.g., SidelinkUEInformationNR) to indicate the consistent LBT failure of a corresponding SL BWP. The BS may configure a new SL carrier to UE to recover the SL communication (e.g., via an RRC Reconfiguration message).

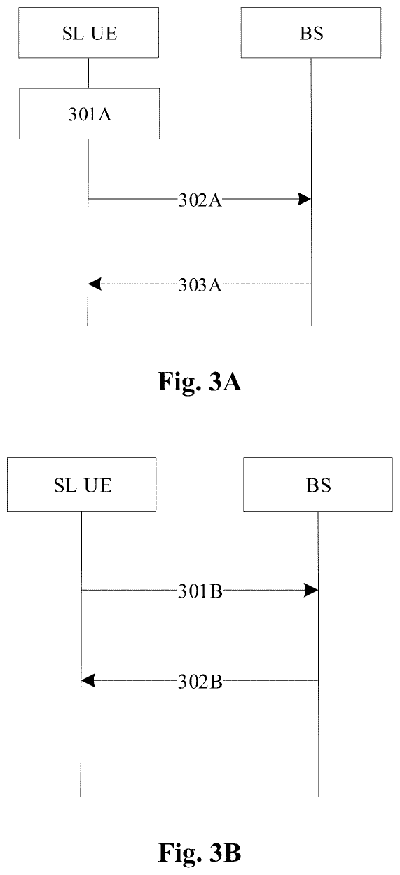

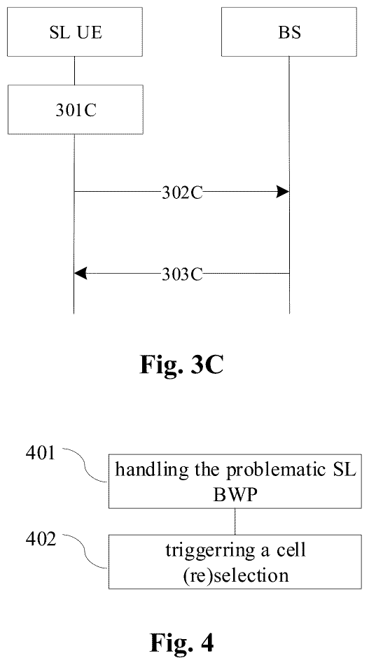

FIGS. 3A-3C illustrate methods performed by an SL UE for handling a consistent LBT failure according to some embodiments of the present disclosure.

In FIG. 3A, the SL UE may be in coverage and operate in resource allocation mode 1.

In operation 301A, when a consistent LBT failure is triggered on the SL BWP (or the UE detects a consistent LBT failure on the SL BWP), the SL UE may handle the problematic BWP, for example, the SL UE may handle the problematic BWP as described in the above solution 1-1 or solution 1-2, i.e., the SL UE may deactivate the SL BWP, or reset the SL BWP.

In operation 302A, the SL UE may indicate a consistent LBT failure of the SL BWP to the BS, for example, the SL UE may transmit an indication, such as a RRC signaling or a MAC CE.

In operation 303A, the BS may configure a new SL BWP, and transmit an SIB or a dedicated signalling indicating the new SL BWP to the SL UE.

In FIG. 3B, the SL UE may be in coverage and operate in resource allocation mode 1.

In operation 301B, when a consistent LBT failure is triggered on the SL BWP (or the UE detects a consistent LBT failure on the SL BWP), the SL UE may indicate a consistent LBT failure of the SL BWP to the BS, for example, the SL UE may transmit an indication, such as by RRC signaling or MAC CE.

In operation 302B, the BS may configure a new SL BWP, and transmit an SIB or a dedicated signalling indicating the new SL BWP to the SL UE.

In FIG. 3C, the SL UE may be in coverage and operate in resource allocation mode 2.

In operation 301C, the SL UE may handle the problematic BWP, for example, the SL UE may handle the problematic BWP as described in the above solution 1-1 or solution 1-2, i.e., the SL UE may deactivate the SL BWP, or reset the SL BWP.

In operation 302C, the SL UE may establish (or reestablish) the RRC connection with the BS and enter into an RRC CONNECTED mode. The SL UE may transmit a RRC signaling to request a new SL BWP.

In operation 303C, the BS may configure a new SL BWP, and transmit an SIB or a dedicated signalling indicating the new SL BWP to the SL UE.

### Option 2-3B

Option 2-3B relates to an SL UE in an RRC IDLE state or an RRC INACTIVE state.

When a consistent LBT failure is triggered on the SL BWP (or the UE detects a consistent LBT failure on the SL BWP), the SL UE may be triggered to perform a cell selection procedure, or a cell reselection procedure.

During the cell selection procedure (or the cell reselection procedure), some cells, for example, may provide a frequency and sidelink configuration(s) of SL communication on an unlicensed band, which may be determined to have a higher priority level than other cells. Accordingly, the SL UE may select the cells with the higher priority level over other cells.

FIG. 4 illustrates a method performed by an SL UE for handling a consistent LBT failure according to some embodiments of the present disclosure.

FIG. 4, the SL UE is in coverage, and operates in mode 2.

In operation 401, when a consistent LBT failure is triggered on the SL BWP (or the UE detects a consistent LBT failure on the SL BWP), the SL UE may handle the problematic BWP, for example, the SL UE may handle the problematic BWP as described in the above solution 1-1 or solution 1-2, i.e., the SL UE may deactivate the SL BWP, or reset the SL BWP.

In operation 402, the SL UE may trigger a cell selection procedure (or cell reselection procedure).

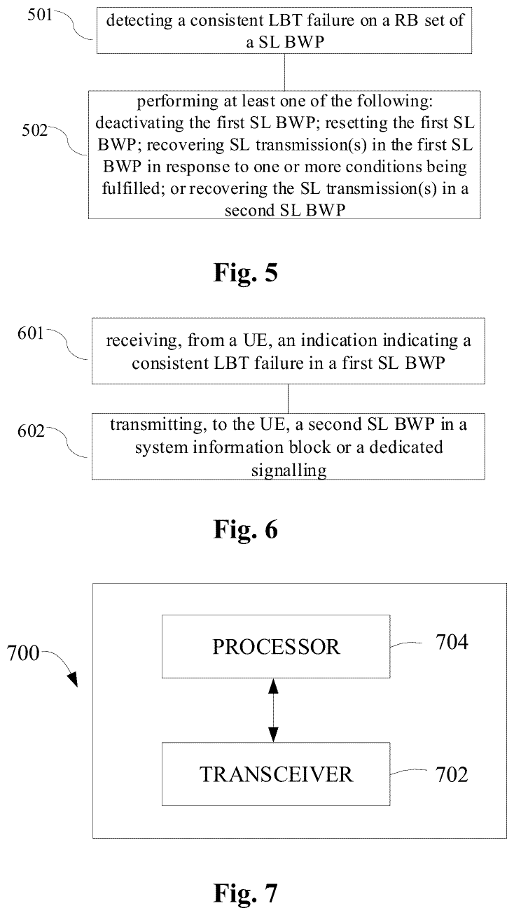

FIG. 5 illustrates a method performed by an SL UE for handling a consistent LBT failure according to some embodiments of the present disclosure.

In operation 501, the SL UE may detect a consistent LBT failure in a first SL BWP. In operation 502, the SL UE may perform at least one of the following: deactivate the first SL BWP; reset the first SL BWP; recover SL transmission(s) in the first SL BWP in response to one or more conditions being fulfilled; or recover the SL transmission(s) in a second SL BWP.

In some embodiments, the UE may determine to deactivate the first SL BWP autonomously; or determine to deactivate the first SL BWP based on an indication from the BS indicating the UE to deactivate the first SL BWP.

In some embodiments, the UE may perform at least one of the following in the first SL BWP: suspend PC5-RRC connection(s) of all established unicast connection(s); trigger a SL RLF for all established unicast connection(s); or release all established unicast connection(s) and indicate the release to an upper layer.

In some embodiments, suspending PC5-RRC connection(s) of all established unicast connection(s) further includes at least one of the following: storing the PC5-RRC configuration(s) of all suspended unicast connection(s); or indicating, to the upper layer, all suspended unicast connection(s).

In some embodiments, the UE may recover all suspended unicast connection(s) in response to the first SL BWP being recovered.

In some embodiments, the UE may determine to reset the first SL BWP autonomously; or determine to reset the first SL BWP based on an indication from the BS indicating the UE to reset the first SL BWP.

In some embodiments, the UE may perform at least one of the following in the first SL BWP:
release DRBs of all destinations;
release SRBs of all destinations;

discard SL communication related configuration(s) of all destinations;
reset SL specific MAC of all destinations; or
consider PC5-RRC connection(s) as released for all unicast destinations.

In some embodiments, the one or more conditions include: a timer being expired (e.g. the condition as described in the above option 2-1A); an LBT success number associated with the first SL BWP being higher than a first threshold (e.g. the condition as described in the above option 2-1B); an LBT failure number associated with the first SL BWP being lower than a second threshold (e.g. the condition as described in the above option 2-1B); a result of a CBR measurement on the first SL BWP being lower than a third threshold (e.g. the condition as described in the above option 2-1C); or an indication from the BS indicating that the first SL BWP is reconfigured (e.g. the condition as described in the above option 2-1D).

In some embodiments, the UE may perform at least one of the following: indicate the consistent LBT failure in the first SL BWP to an upper layer; transmit an indication indicating the consistent LBT failure in the first SL BWP to the BS; or trigger a cell section procedure or a cell resection procedure.

In some embodiments, the upper layer is configured to perform at least one of the following: stop SL transmission to all destinations; suspend or release all unicast connections; or configure the second SL BWP.

In some embodiments, the indication indicating the consistent LBT failure in the first SL BWP includes a MAC CE or a RRC signalling.

In some embodiments, the RRC signalling indicating the consistent LBT failure in the first SL BWP includes at least one of the following:
an RRC setup request message including a cause or an IE that indicates the consistent LBT failure in the first SL-BWP; an RRC setup complete message including an IE that indicates the consistent LBT failure in the first SL-BWP;
an RRC resume message including an IE that indicates the consistent LBT failure in the first SL-BWP;
an RRC resume complete message including an IE that indicates the consistent LBT failure in the first SL-BWP;
an RRC reestablishment message including an IE that indicates the consistent LBT failure in the first SL-BWP;
an RRC reestablishment complete message including an IE that indicates the consistent LBT failure in the first SL-BWP; or
an SL UE information message, wherein the SL UE information message includes an SL failure IE with an parameter of destination indicating the consistent LBT failure is associated with all destinations or associated with the first SL-BWP, and includes a cause that indicates the consistent LBT failure in the first SL-BWP; or wherein the SL UE information message includes an IE that indicates the consistent LBT failure in the first SL-BWP.

In some embodiments, the UE may receive a system information block or a dedicated signalling indicating the second SL BWP.

In some embodiments, the UE may perform at least one of the following: release stored PC5-RRC configurations; apply PC5-RRC configurations for the second SL BWP; or recover all suspended unicast connection(s).

In some embodiments, the UE may select a cell with a higher priority level during the cell section procedure or the cell resection procedure, wherein the cell with a higher priority level is associated with SL communications in an unlicensed band.

FIG. 6 illustrates a method performed by a BS for handling a consistent LBT failure according to some embodiments of the present disclosure.

In operation 601, the BS may receive, from a UE, an indication indicating a consistent LBT failure in a first SL BWP. In operation 602, the BS may transmit, to the UE, a second SL BWP in a system information block or a dedicated signalling.

In some embodiments, the indication includes a MAC CE or a RRC signalling.

FIG. 7 illustrates a simplified block diagram of an exemplary apparatus according to some embodiments of the present disclosure.

As shown in FIG. 7, an example of the apparatus 700 may include at least one processor 704 and at least one transceiver 702 coupled to the processor 704. The apparatus 700 may be a UE, an SL UE, a Tx SL UE, an Rx SL UE, a BS, a RAN node, or any other device with similar functions.

Although in this figure, elements such as the at least one transceiver 702 and processor 704 are described in the singular, the plural is contemplated unless a limitation to the singular is explicitly stated. In some embodiments of the present disclosure, the transceiver 702 may be divided into two devices, such as a receiving circuitry and a transmitting circuitry. In some embodiments of the present disclosure, the apparatus 700 may further include an input device, a memory, and/or other components.

In some embodiments of the present disclosure, the apparatus 700 may be a UE. The transceiver 702 and the processor 704 may interact with each other so as to perform the operations of the UE described in any of FIGS. 1-6. In some embodiments of the present disclosure, the apparatus 700 may be a node. The transceiver 702 and the processor 704 may interact with each other so as to perform the operations of the node described in any of FIGS. 1-6.

In some embodiments of the present disclosure, the apparatus 700 may further include at least one non-transitory computer-readable medium.

For example, in some embodiments of the present disclosure, the non-transitory computer-readable medium may have stored thereon computer-executable instructions to cause the processor 704 to implement the method with respect to the UE as described above. For example, the computer-executable instructions, when executed, cause the processor 704 interacting with transceiver 702 to perform the operations of the UE described in any of FIGS. 1-6.

In some embodiments of the present disclosure, the non-transitory computer-readable medium may have stored thereon computer-executable instructions to cause the processor 704 to implement the method with respect to the node as described above. For example, the computer-executable instructions, when executed, cause the processor 704 interacting with transceiver 702 to perform the operations of the node described in any of FIGS. 1-6.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
detect a consistent listen before talk (LBT) failure in a first sidelink (SL) bandwidth part (BWP);
perform at least one of the following:
deactivate the first SL BWP;
reset the first SL BWP;
recover SL transmissions in the first SL BWP in response to one or more conditions being fulfilled; or
recover the SL transmissions in a second SL BWP.

2. The UE of claim 1, wherein the at least one processor is further configured to cause the UE to:
determine to deactivate the first SL BWP autonomously; or
determine to deactivate the first SL BWP based on an indication from a base station (BS) indicating the UE to deactivate the first SL BWP.

3. The UE of claim 2, wherein the at least one processor is further configured to cause the UE to perform at least one of the following in the first SL BWP:
suspend PC5 interface radio resource control (PC5-RRC) connections of all established unicast connections;
trigger a SL radio link failure (RLF) for all established unicast connections; or
release all established unicast connections and indicate the release to an upper layer.

4. The UE of claim 3, wherein suspending PC5-RRC connections of all established unicast connections further includes at least one of the following:
storing the PC5-RRC configurations of all suspended unicast connections; or
indicating, to the upper layer, all suspended unicast connections.

5. The UE of claim 3, wherein the at least one processor is further configured to cause the UE to recover all suspended unicast connections in response to the first SL BWP being recovered.

6. The UE of claim 1, wherein the at least one processor is further configured to cause the UE to:
determine to reset the first SL BWP autonomously; or
determine to reset the first SL BWP based on an indication from a base station (BS) indicating the UE to reset the first SL BWP.

7. The UE of claim 1, wherein the one or more conditions include:
a timer being expired;
an LBT success number associated with the first SL BWP being higher than a first threshold;
an LBT failure number associated with the first SL BWP being lower than a second threshold;
a result of a channel busy ratio (CBR) measurement on the first SL BWP being lower than a third threshold; or an indication from base station (BS) indicating that the first SL BWP is reconfigured.

8. The UE of claim 1, wherein the at least one processor is further configured to cause the UE to perform at least one of the following:
indicate the consistent LBT failure in the first SL BWP to an upper layer;
transmit an indication indicating the consistent LBT failure in the first SL BWP to a base station (BS); or
trigger a cell section procedure or a cell resection procedure.

9. The UE of claim 8, wherein the upper layer is configured to perform at least one of the following:
stop SL transmission to all destinations;
suspend or release all unicast connections; or
configure the second SL BWP.

10. The UE of claim 8, wherein the indication indicating the consistent LBT failure in the first SL BWP includes a medium access control (MAC) control elements (CE) or a radio resource control (RRC) signaling.

11. The UE of claim 10, wherein the RRC signaling indicating the consistent LBT failure in the first SL BWP includes at least one of the following:
an RRC setup request message including a cause or an information element (IE) that indicates the consistent LBT failure in the first SL-BWP;
an RRC setup complete message including an IE that indicates the consistent LBT failure in the first SL-BWP;
an RRC resume message including an IE that indicates the consistent LBT failure in the first SL-BWP;
an RRC resume complete message including an IE that indicates the consistent LBT failure in the first SL-BWP;
an RRC reestablishment message including an IE that indicates the consistent LBT failure in the first SL-BWP;
an RRC reestablishment complete message including an IE that indicates the consistent LBT failure in the first SL-BWP; or
an SL UE information message, wherein the SL UE information message includes an SL failure IE with an parameter of destination indicating the consistent LBT failure is associated with all destinations or associated with the first SL-BWP, and includes a cause that indicates the consistent LBT failure in the first SL-BWP; or wherein the SL UE information message includes an IE that indicates the consistent LBT failure in the first SL-BWP.

12. The UE of claim 8, wherein the at least one processor is further configured to cause the UE to:
receive a system information block or a dedicated signaling indicating the second SL BWP.

13. The UE of claim 8, wherein the at least one processor is further configured to cause the UE to:
select a cell with a higher priority level during the cell section procedure or the cell resection procedure, wherein the cell with a higher priority level is associated with SL communications in an unlicensed band.

14. A base station (BS) for wireless communication, comprising:
at least one memory; and
least one processor coupled with the at least one memory and configured to cause the BS to:
receive, from a user equipment (UE), an indication indicating a consistent listen before talk (LBT) failure in a first sidelink (SL) bandwidth part (BWP); and
transmit, to the UE, a second SL BWP in a system information block or a dedicated signaling.

15. A method performed by a user equipment (UE), the method comprising:
detecting a consistent listen before talk (LBT) failure in a first sidelink (SL) bandwidth part (BWP); and
performing at least one of the following:
deactivating the first SL BWP;
resetting the first SL BWP;
recovering SL transmissions in the first SL BWP in response to one or more conditions being fulfilled; or
recovering the SL transmissions in a second SL BWP.

16. A processor for wireless communication, comprising:
at least one controller coupled with the at least one memory and configured to cause the processor to:
detect a consistent listen before talk (LBT) failure in a first sidelink (SL) bandwidth part (BWP);
perform at least one of the following:
deactivate the first SL BWP;
reset the first SL BWP;
recover SL transmissions in the first SL BWP in response to one or more conditions being fulfilled; or
recover the SL transmissions in a second SL BWP.

17. The processor of claim 16, wherein the at least one controller is further configured to cause the processor to:
determine to deactivate the first SL BWP autonomously; or
determine to deactivate the first SL BWP based on an indication from a base station (BS) indicating the UE to deactivate the first SL BWP.

18. The processor of claim 17, wherein the at least one controller is further configured to cause the processor to perform at least one of the following in the first SL BWP:
suspend PC5 interface radio resource control (PC5-RRC) connections of all established unicast connections;
trigger a SL radio link failure (RLF) for all established unicast connections; or
release all established unicast connections and indicate the release to an upper layer.

19. The processor of claim 16, wherein the one or more conditions include:
a timer being expired;
an LBT success number associated with the first SL BWP being higher than a first threshold;
an LBT failure number associated with the first SL BWP being lower than a second threshold;
a result of a channel busy ratio (CBR) measurement on the first SL BWP being lower than a third threshold; or
an indication from a base station (BS) indicating that the first SL BWP is reconfigured.

20. The processor of claim 16, wherein the at least one controller is further configured to cause the processor to perform at least one of the following:
indicate the consistent LBT failure in the first SL BWP to an upper layer;
transmit an indication indicating the consistent LBT failure in the first SL BWP to a base station (BS); or
trigger a cell section procedure or a cell resection procedure.
